(19) United States
(12) Patent Application Publication
(10) Pub. No.: US 2012/0012138 A1
(43) Pub. Date: Jan. 19, 2012

(54) Portable rack with cleaning nozzles

(76) Inventor: Gilbert Garrett, Hot Springs, AR (US)

(21) Appl. No.: 13/135,744

(22) Filed: Jul. 14, 2011

Related U.S. Application Data
(60) Provisional application No. 61/399,845, filed on Jul. 16, 2010.

(51) Int. Cl. B08B 3/04

(52) U.S. Cl. 134/123

(57) ABSTRACT

The invention includes a wash station that sprays water onto a vehicle traversing the station to remove debris. The portable tire rack station includes an elongated frame with folding ramps at each end and a hollow longitudinal tube on one frame end that provides internal fluid communication to spray ports in the frame. A grate spanning the frame supports the vehicle during station traversal and vibrates the vehicle as it traverses the station to remove debris therefrom. An entry port in the frame receives remote water for the spray ports that selectively discharge the water to remove trapped debris from the station and into a suitable containment area or collection tray.

### CROSS-REFERENCE TO RELATED APPLICATIONS

This application claims priority to and is a continuation of patent application Ser. No. 61/399,845, filed Jul. 16, 2010, entitled Portable Rack with Cleaning Nozzles.

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

1. Field of the Invention

The invention pertains to improvements in vehicle undercarriage and wheel cleaning to remove contaminants therefrom and particularly the arrangement of the apparatus and mechanism associated therewith. Known art can be found in Class 256, subclass 17, and in Class 404, subclass 15 and in Class 134, subclasses 34 and 104.1 and in other classes and subclasses.

2. Description of the Known Art

Those skilled in the art will appreciate that it is often desirable to employ tire racks and/or wash stations to remove contaminants from a vehicle and especially the tires and undercarriages of the vehicle. Often a vehicle enters a locale and the vehicle subsequently becomes contaminated with materials from the locale. For example, contaminants such as salt, chemicals, dirt, silt mud, construction trash, insects, organic wastes such as bovine, swine or poultry litter and/or hair or feathers and other contaminants can be present at a particular locale. These contaminants often contact vehicle wheels and undercarriages as the vehicle traverses the locale. It is often desirable to remove any contaminants that may become lodged or otherwise stuck to the vehicle from it to prevent such materials from leaving with the vehicle. These materials also can cause corrosion if they are not removed, resulting in damage to the vehicle that can necessitate costly repairs.

Motorized and unmotorized vehicle undercarriage and tire cleaning systems are desirable for removing debris from the undercarriage and wheels of vehicles. Vehicle undercarriage cleaners clean the undercarriage of vehicles and remove materials from areas of a vehicle while tire racks vibrate or jostle the tires to remove debris.

Most previously proposed solutions for such problems have not provided devices that are easily deployable and that thoroughly remove contaminants with large volumes of rinse water or that provide for the subsequent removal of the debris easily from the tire rack or the like. Therefore, a need exists for a new and improved tire rack cleaner that can be used for cleaning the undercarriage and wheels of vehicles. Thus, an improved system with efficient contaminant removal that addresses the perceived shortcomings of the known art is desirable.

Know art which may be relevant to the present invention includes the following patents with their abstracts, the teachings of which are incorporated by reference.

U.S. Pat. No. 7,163,351, issued to Shaver on Jan. 16, 2007, entitled Tire Cleaning Apparatus, is for a tire cleaning apparatus that provides a vibration-inducing surface for a vehicle passing over the tire cleaning apparatus in order to remove dirt and debris from the tires of the vehicle. The tire cleaning apparatus includes at least one tire-cleaning frame, which is formed from a plurality of upper C-shaped beams, which are secured to a plurality of lower C-shaped beams in a rectilinear grid-shaped pattern. Sidewalls of the upper C-shaped beams, which project upwardly, form the vibration-inducing surface, and channels formed in the upper C-shaped beams allow for the collection of dirt and debris, and also provide for the drainage of water. Similar sidewalls of the lower C-shaped beams engage the ground for secure positioning of the tire-cleaning frame.

U.S. Pat. No. 5,203,544, issued to Webb on Apr. 20, 1993, entitled Cattle Guard, is for a cattle guard that includes a base and grills which may easily be removed for cleaning without disturbing the adjacent roadway. The cattle guard includes side wings which are attached to the base to ease the removal of the grills. In a further aspect, the ends of the base include angled portions designed to facilitate funneling of water through the base while preventing ground erosion. While the patent discusses funneling water, this is directed to ground water and not for cleaning the guard to remove debris.

U.S. Pat. No. 6,358,330 to McGraw issued on Mar. 19, 2002, which is for an apparatus for washing mud, dirt and silt from the tires of a truck leaving a construction site includes a water supply line, a collection basin and a grate positioned over the collection basin. The apparatus further includes an optional side rail attached to the collection basin above the grate and an optional drainage system comprising a plurality of drain ports formed in the collection basin. Preferably, water from an external water source flows through the water supply line to a selector valve in fluid communication with the grate and the side rail. The grate comprises a plurality of spray tubes having a plurality of spray ports formed therein and the side rail comprises at least one side rail spray tube having a plurality of side rail spray ports formed therein. The selector valve may be positioned to permit water to flow only to the grate, to the grate and the side rail, or only to the side rail. The truck is driven over the grate and the water delivered to the spray ports is directed onto the tires of the truck. The mud, dirt and silt and the run-off water collects in the collection basin. Once the level of the run-off water reaches the level of the drain ports of the drainage system, the run-off water is drained from the collection basin to a recycling tank or a storm drain. Once the mud, dirt and silt reach a predetermined amount, it is removed from the collection basin.

U.S. Pat. No. 5,383,742 to Grace issued Jan. 24, 1995, entitled Dirt and rock removal apparatus for vehicle tires, is for an apparatus for removing dirt and rocks from the tires of trucks and other vehicles comprises a number of elongate rigid metal ribs attached in a transverse direction to a rigid metal plate. The longitudinal spacing between the ribs, taken in conjunction with the height of the ribs relative to the upper surface of the mounting plate prevents the peripheral (i.e., the pavement contacting) surface of a tire rolling over the apparatus in a longitudinal direction from contacting the upper surface of the plate so that dirt and rocks, dislodged from the tire by the tire flexing over the ribs, fall to regions of the plate between the ribs and are not picked up by following ones of the vehicle tires as they roll over the apparatus. The plate, which may be about twelve feet long and about eight feet wide, is preferable constructed in two sections, each about six feet long by about eight feet wide to enhance portability. Pins extend through abutting ribs to detachably connect the two plate sections together.

U.S. Pat. No. 4,655,435 to Joseph, Jr., et al, issued Apr. 7, 1987, entitled Cattle guard, is for a cattle guard has a grid with a plurality of spaced bars lying transverse to the direction of travel across the guard. The bars are supported by a plurality of spaced beams lying beneath the bars. The grid, in turn, is supported by a base in the ground. The base comprises a pair of side members positioned transverse to the direction of travel across the guard. Each of the side members has a side wall with a box-like flange member lying normal to the side wall and extending into the base. The grid rests on the flange member when the cattle guard is assembled and retained in position with respect to the base by locking elements. A plurality of columns extend between upper and lower walls of the flange member to support the grid. The base has a pair of end walls fastened to the side members during installation to complete the construction of the base.

U.S. Pat. No. 5,131,631 to Cobbe, issued Jul. 21, 1992, entitled Portable pitless livestock gate, is for a portable pitless livestock barrier whereby vehicles or humans may easily gain access to a livestock enclosure but provides a deterrent to the unwanted passage of the livestock from such enclosure. The barrier is provided by having a horizontal main frame to be placed on the ground with a vertical frame supported and attached to each side of the main frame. Within the boundaries of the main frame are two platform grates that are connected to the main frame at the exit and entrance to the barrier but can be adjustably raised in the central area of the barrier by a spring biased lever lifting mechanism attached to each vertical frame which allows the platform grates to be forced to the ground when a vehicle passes over but when the vehicle has passed the grates regain their inclined position giving a perception of depth or poor footing to the livestock thereby providing a deterrent to their passage.

U.S. Pat. No. 5,419,537 to Thompson, issued May 30, 1995, entitled Pop-up stock guard, is for a portable cattle guard is provided which includes an assembled rectangularly shaped base member. Contained within the confines of the base member are a pair of inclined cattle ramps movably connected along their longitudinal axis to a smaller, spring biased center ramp. The base member includes a pair of hollow vertical posts having inwardly facing guide slots cut therein. Each hollow post contains a coil spring assembly fixed to support the center ramp in normally upward attitude and depressible to a flat ramp configuration to allow vehicle passage.

U.S. Pat. No. 3,971,546 to Bruner, issued Jul. 27, 1976, entitled Animal crossing guard, is for an animal crossing guard has a rectangular frame, bars extending across the frame at 45.degree., transverse members extending directly across the frame securing opposite frame members from spreading and supporting the bars intermediate their ends, and identical brackets bolted to the frame and overlapping each other to receive the ends of the bars mounting the bars and spacing them apart at regular intervals forming a grid.

U.S. Pat. No. 6,895,978 to Midkiff issued May 24, 2005, which is for an apparatus for washing the wheels and tires of heavy duty vehicles includes a wash trough in which the wheels and tires are washed, and a refuse trough in which refuse from the vehicles is deposited for facile removal. The troughs are separated by a wall having a space therein through which debris from the wash trough is impelled, by a stream of water into the refuse trough.

U.S. Pat. No. 6,981,818 to Lange issued Jan. 3, 2006, which is for a method for shaking vehicles comprises driving them over a series of appropriately spaced-apart, mutually parallel bars to vigorously shake the wheels, undercarriage, and body to free them of dirt, gravel and debris. An apparatus may have bars with the appropriate spacing. A track may include a frame and the spaced-apart bars may form part of the frame. The track may be large enough to accommodate all the wheels of a vehicle at once. Alternatively, smaller tracks may be flexibly connected end-to-end to form a shaker that will receive right and left hand wheels of the vehicle on respective rows. The shaker may be deployed onto a bed of aggregate that is sufficiently coarse to allow the fallen dirt to sift or be washed through the bed of aggregate. The aggregate may also assist in holding the shaker in place and may provide ramps at the ends of the shaker.

U.S. Pat. No. 6,779,744 to Marine, et al. issued Aug. 24, 2004, which is for a vehicle undercarriage cleaners clean the undercarriage of vehicles. Dirt, mud, salt, chemicals, snow and other materials accumulate on the undersides of vehicles. The vehicle undercarriage cleaner removes these materials without requiring the user to manipulated during use by employing a set of interlocking pipes and joints laid out to form a nested rectangle. Water holes piercing the top surface of the pipes result in sprays of water when a hose is connected to the hose attachment mechanism. Addition or removal of pipes and joints allows the dimensions of the vehicle undercarriage cleaner to be adjusted to accommodate any vehicle.

Also, commercially available equipment and components may be relevant, including commercial pressure washers and the like. Such equipment may be used in implementing an exemplary embodiment in accordance with the present invention.

None of these references, either singly or in combination, disclose or suggest the present invention. It is desirable to have an improved portable tire rack and rinse system to address the perceived shortcomings of the prior art.

While it is evident from past attempts that undercarriage and tire debris removal is desirable, the known art is limited in its teaching and utilization, and an improved system is needed to overcome these limitations. An improved tire rack and rinse system should provide a simple and efficient system for meeting the various needs of field personnel. The system should enable the user to work efficiently in the field or at other remote locales as desired. The system should be adaptable to retrofit to existing locales such as animal husbandry facilities, construction sites and the like.

### SUMMARY OF THE INVENTION

The present invention addresses the perceived needs in the known art discussed above. In this regard, the present invention substantially fulfills this need. The vehicle undercarriage cleaner according to the present invention substantially departs from the conventional concepts and designs of the prior art, and in doing so provides an apparatus primarily developed for the purpose of cleaning the undercarriage of vehicles.

In one exemplary embodiment in accordance with the present invention an improved tire rack station using vibration bars to remove contaminants from vehicles and the like is provided. The portable tire rack station includes an elongated platform that may be deployed on a supporting flat surface. The platform includes a grate spanning the entire platform (although it would be possible to use only spaced apart treadways) that the vehicle's tires traverse as the vehicle moves across the platform. The platform incorporates hollow members into its structure to facilitate the movement of water through the structure and into various outlet ports associated with the platform that spray water into the tire rack to remove retained contaminants falling from the vehicle as it passes across the platform on the treadways. The platform includes an elongated frame with folding ramps at each end. The treadway or grate supports the vehicle during station traversal and they vibrate the vehicle as it traverses the station to remove debris therefrom. An entry port in the frame receives remote water for the spray ports that selectively discharge the water to remove trapped debris from the station and into a suitable containment area or collection tray.

In another exemplary embodiment, the platform may include a retention system deployed beneath the platform that collects dislodged materials on its surface and particularly poultry feathers and the like.

The apparatus of the invention is capable of receiving additional, optional features which are not a part of the present invention. For example, a purchaser or user may specify an optional timed feature whereby the station will cycle automatically to remove contaminants from the rack after a vehicle passes or another suitable threshold is reached, such as time or quantity of debris. Also an optional feature is available whereby the control system for the rinse station is provided with a remote control panel connected by a short cable to the main control unit. According to the invention such a remote control would include operator identification features also. Other optional features, some of which are illustrated herein, may or may not be included with apparatus incorporating the basic aspects of present invention.

In addition to providing the features and advantages referred to above, it is an object of the present invention to provide a tire rack station that thoroughly removes contaminants from a vehicle passing over the station.

It is another object of the present invention to provide a tire rack station including a retention system for collected dislodged materials.

It is still another object of the present invention to provide a tire rack station that removes contaminants from vehicles in a single pass over the station.

It is a further object of the present invention to provide a tire rack station that is easily deployable with minimal site preparation.

It is a still further object of the present invention to provide a tire rack station that traps debris entrained in rinse waters.

It is an object of the present invention to provide an improved cleaning system that may be used by service personnel at field locations.

It is an object of the present invention to provide a station that may be easily retrofitted and adapted to existing locales such as construction sites, animal husbandry sites, wastes disposal sites and the like.

It is a further object of the present invention to provide a system that may be easily maintained.

It is a still further object of the present invention to provide a system that is quickly and easily deployable by a user.

These and other objects and advantages of the present invention, along with features of novelty appurtenant thereto, will appear or become apparent by reviewing the following detailed description of the invention in conjunction with the appended drawings.

### BRIEF DESCRIPTION OF THE SEVERAL VIEWS OF THE DRAWINGS

In the following drawings, which form a part of the specification and which are to be construed in conjunction therewith, and in which like reference numerals have been employed throughout wherever possible to indicate like parts in the various views:

FIG. 1 is an perspective view taken generally from the top of one exemplary embodiment of the portable rack with cleaning nozzles at a site in accordance with the present invention;

FIG. 2 is a top plan view thereof;

FIG. 3 is an end view thereof and taken generally from the front with phantom lines showing interior structure;

FIG. 4 is side elevational view with a ramp folded and a ramp unfolded and taken generally from the right side thereof; and,

FIG. 5 is an enlarged perspective view of the encircled portion of FIG. 1.

### DETAILED DESCRIPTION OF THE INVENTION

The present invention addresses the perceived needs in the known art discussed above. In this regard, the present invention substantially fulfills this need. The vehicle cleaner according to the present invention substantially departs from the conventional concepts and designs of the known art, and in doing so provides an apparatus primarily developed for the purpose of cleaning vehicles to remove debris.

The present invention provides a tire rack station that thoroughly removes contaminants from a vehicle passing across the station. The present invention also provides a rinse system that removes contaminants from the station as desired. The rinse system is easily deployable with minimal site preparation. The present invention provides an improved cleaning system that may be used by service personnel at field locations. The present invention provides a portable tire rack station that may be easily retrofitted and adapted to existing locales such as construction sites, animal husbandry sites, wastes disposal sites and the like. In another exemplary embodiment of the present invention, the invention provides a station apparatus including a retention system for collecting dislodged materials. The present invention can essentially trap debris entrained in rinse waters for subsequent disposal.

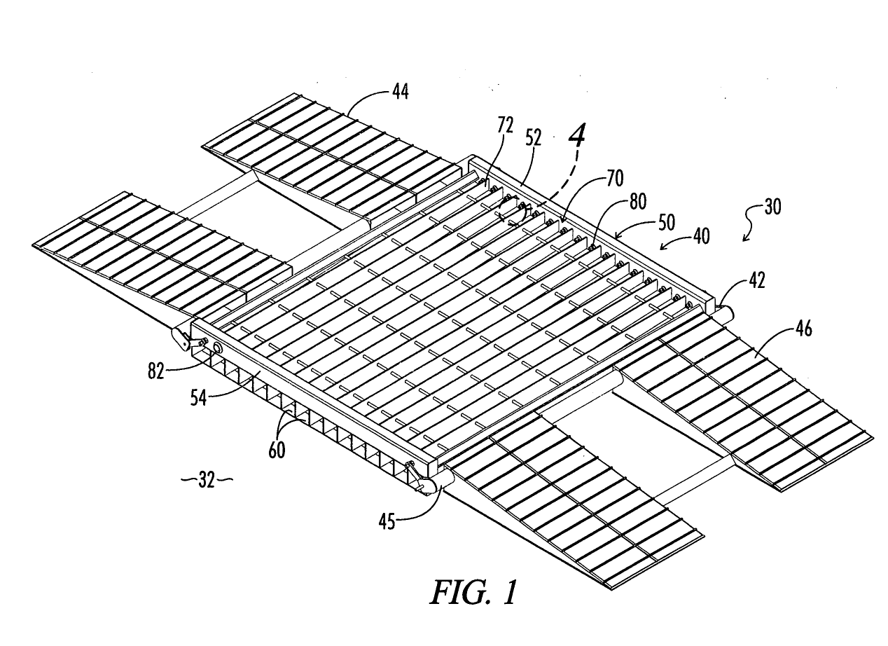

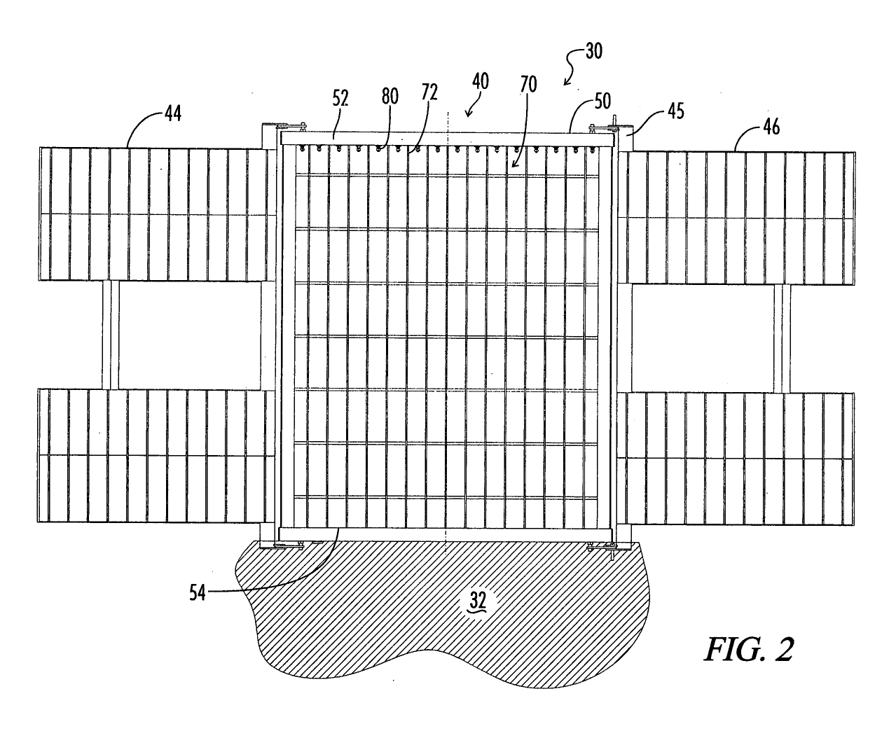

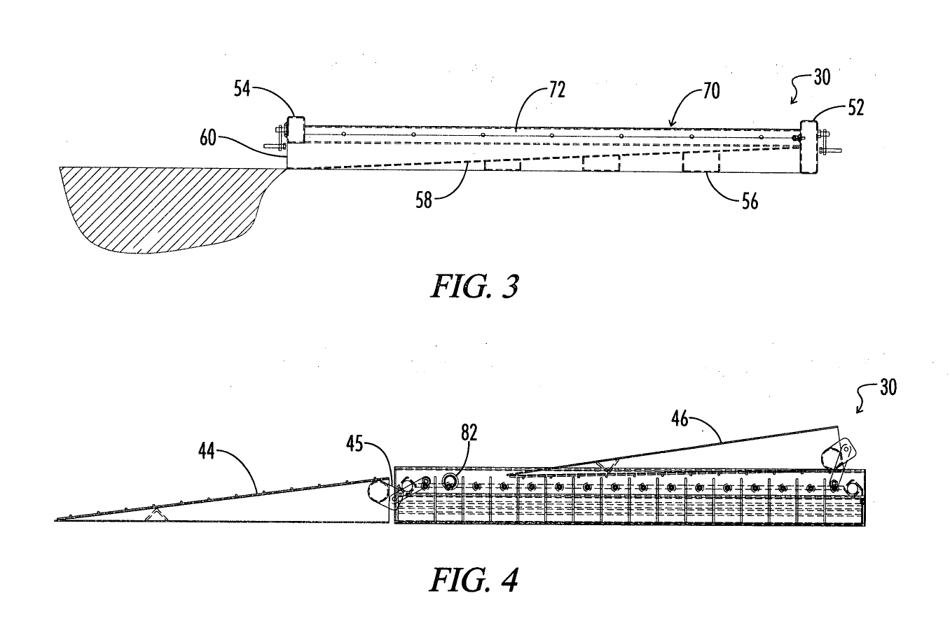

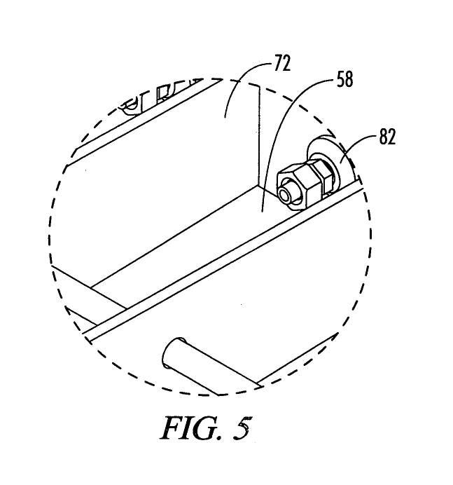

In one exemplary embodiment shown in FIGS. 1-5, the cleaning system is generally indicated by reference numeral 30. The cleaning system 30 in accordance with the present invention provides an improved tire rack station 40 that removes contaminants from vehicles passing over the station. The station 40 includes an elongated platform 42 and entry and exit ramps 44, 46, connected via offset hinges 45. The station 40 may be deployed on a supporting flat surface such as the ground 32 or a concrete pad or the like.

The platform includes a grate 70 that supports the vehicle's tires when it crosses the platform 42. The platform 42 incorporates at least one hollow member in its frame 50 to facilitate the movement of water through the structure and into various outlet ports associated with the platform that spray water into the station to remove debris therefrom. The platform 42 includes a substantially rigid frame 50 supporting a substantially rigid grate 70.

The frame 50 includes several rigid members that are coupled together to form a supporting structure for the grate 70. The frame 50 has at least two spaced apart and generally parallel tubes 52, 54 that form the longitudinal exterior edges of the frame 50. These tubes 52, 54 also extend above the grid to form a longitudinal peripheral curb to keep the vehicle inside the perimeter of the station 40 as the vehicle traverses the station 40.

The longitudinal tubes 52, 54 may be made from any rigid material such as steel, iron, aluminum, etc., that will support the weight of passing vehicles while also having a sufficient internal cavity to provide an internal fluid flow pathway. In one exemplary embodiment, the tubes 52, 54 have a rectangular cross-section of approximately 2 inches by 8 inches and the tubes are 8 feet 5 inches in length and the tubes are made from steel. At least one of the tubes 52, 54 includes an entry port 82 formed therein that permits the entry of water into the tube 52, 54, as will be more thoroughly discussed hereinafter.

The tubes 52, 54 are supported by several transverse hollow tubes 56. As with the longitudinal tubes 52, 54, the transverse tubes 56 may be made from any rigid material such as steel, iron, aluminum, etc., that will support the weight of passing vehicles. In one exemplary embodiment, the tubes 56 have a rectangular cross-section of approximately 2 inches by 4 inches and the tubes are 8 feet 5 inches in length and the tubes are made from steel. The transverse tubes 56 also support a sloping floor 58 that runs from a high side adjacent the bottom of tube 52 to a low side beneath tube 54 and to a series of outlets 60 adjacent the end of each individual member of the grate 70.

The tubes 52, 54, 56 may be secured together in a number of manners including permanently with welding, riveting, or the like or coupled with nuts and bolts or screws or the like. In one exemplary embodiment, it has been found that 2 inch carriage bolts and nuts work acceptably for joining tubes when coupled to peripheral brackets with mounting holes and with the brackets secured (generally by welding) at appropriate locations.

The grate 70 includes several elongated members 72 spanning between the longitudinal tubes 52, 54. The members 72 are regularly spaced between tubes 52, 54. The members 72 provide a slotted surface that the vehicle may travel upon as it moves across the station 40. The members 72 may be made from many materials but in one preferred embodiment, the members 72 are made from steel and are generally identified as 3 inch channel. The members 72 are approximately 3 inches in width and approximately 9 feet 3 inches in length. The members 72 may be secured at each terminal end to the longitudinal tubes 52, 54 by welding or the like. The members 72 have spaces between adjacent members so that debris and the like may pass through the grate 70 and onto the floor 58.

In another exemplary embodiment, the platform 40 may act as a retention system to collect the dislodged materials and particularly poultry feathers and the like. The platform retains the dislodged materials until washed out by water through spray ports 80. The retained materials may be collected or buried or otherwise suitably disposed of as desirable.

The spray ports 80 discharge high volumes of low pressure water into the platform 40 to remove debris therefrom. The spray ports 80 receive water through the frame 50 from an entry port 82. Entry port 82 receives the water from a remote source such as a water supply tank, municipal water source, well or the like. The entry port 82 is connected to the remote water source with a conventional piping arrangement (not shown).

The apparatus of the invention is capable of receiving additional, optional features as well. For example, a purchaser or user may specify an optional multi-cycle control feature whereby the rinse station will cycle two or more times at each operation of the start button. Also an optional feature is available whereby the control system for the rinse station is provided with a remote control panel connected by a short cable to the main control unit. According to the invention such a remote control would include operator identification features also. Other optional features, some of which are illustrated herein, may or may not be included with apparatus incorporating the basic aspects of present invention.

In describing a preferred embodiment of the invention illustrated in the drawings, specific terminology has been used for the sake of clarity. However, the invention is not intended to be limited to the specific terms selected, and it is to be understood that each specific term includes all technical equivalents which operate in a similar manner to accomplish a similar purpose.

What is claimed is:

1. A wash station that receives water at an entry port from a remote water source and then selectively discharges the water to remove trapped debris from a vehicle traversing the station into a suitable containment area or collection tray, the station comprising:
an elongated frame with an entry port for receiving water;
spaced apart ramps at each end of the frame;
a plurality of spray ports adapted to disperse water;
a hollow longitudinal tube on one frame end that provides internal fluid communication between the entry port and the spray ports in the frame; and,
a grate spanning the frame.

2. The station as recited in claim 1 wherein the grate is adapted to support the vehicle during station traversal and vibrates the vehicle as it traverses the station to assist in debris removal.

3. The station as recited in claim 1 wherein the entry port is located adjacent an end of the frame and the spray ports are located along one side of the frame opposite the entry port.

4. The station as recited in claim 3 wherein the frame includes a top adjacent the grate and a spaced apart floor and where the floor slopes from one frame side to the other frame side to move water from the spray ports across the frame and out of the frame.

5. The station as recited in claim 4 wherein the grate further comprises a plurality of members that each extend substantially across the entire top of the frame and each member is angled upwardly with respect to the plane of the frame top to vibrate a vehicle traversing the station.

6. The station as recited in claim 1 wherein the ramps are hinged to opposite frame ends and adapted to move between a deployed and a stowed configuration to facilitate station portability.

7. The station as recited in claim 1 further comprising a collection pit adjacent the entry port for receiving debris flushed from the frame by water.

8. The station as recited in claim 1 wherein the frame further comprises a plurality of vertical walls establishing fluid flow pathways from the side adjacent the spray ports to the opposite frame side.

9. A wash station that receives water at an entry port from a remote water source and then selectively discharges the water to remove trapped debris from a vehicle traversing the station into a suitable containment area or collection tray, the station comprising:
an elongated frame with an entry port for receiving water;
spaced apart ramps at each end of the frame;
a plurality of spray ports adapted to disperse water;
a hollow longitudinal tube on one frame end that provides internal fluid communication between the entry port and the spray ports in the frame; and,
a vibratory grate spanning the frame and adapted to support the vehicle during station traversal and which vibrates the vehicle as it traverses the station to assist in debris removal.

10. The station as recited in claim 9 wherein the entry port is located adjacent an end of the frame and the spray ports are located along one side of the frame opposite the entry port.

11. The station as recited in claim 10 wherein the frame includes a top adjacent the grate and a spaced apart floor and where the floor slopes from one frame side to the other frame side to move water from the spray ports across the frame and out of the frame.

12. The station as recited in claim 11 wherein the grate further comprises a plurality of members that each extend substantially across the entire top of the frame and each member is angled upwardly with respect to the plane of the frame top to vibrate a vehicle traversing the station.

13. The station as recited in claim 9 wherein the ramps are hinged to opposite frame ends and adapted to move between a deployed and a stowed configuration to facilitate station portability.

14. The station as recited in claim 9 further comprising a collection pit adjacent the entry port for receiving debris flushed from the frame by water.

15. The station as recited in claim 9 wherein the frame further comprises a plurality of vertical walls establishing fluid flow pathways from the side adjacent the spray ports to the opposite frame side.

16. A portable wash station that receives water at an entry port from a remote water source and then selectively discharges the water to remove trapped debris from a vehicle traversing the station into a suitable containment area or collection tray, the station comprising:
an elongated frame with an entry port for receiving water;
spaced apart ramps hinged to opposite frame ends and adapted to move between a deployed and a stowed configuration to facilitate station portability;
a plurality of spray ports adapted to disperse water;
a hollow longitudinal tube on one frame end that provides internal fluid communication between the entry port and the spray ports in the frame; and,
a vibratory grate spanning the frame and adapted to support the vehicle during station traversal and which vibrates the vehicle as it traverses the station to assist in debris removal.

17. The station as recited in claim 16 wherein the entry port is located adjacent an end of the frame and the spray ports are located along one side of the frame opposite the entry port and the frame further comprises a plurality of vertical walls establishing fluid flow pathways from the side adjacent the spray ports to the opposite frame side.

18. The station as recited in claim 17 wherein the frame includes a top adjacent the grate and a spaced apart floor and where the floor slopes from one frame side to the other frame side to move water from the spray ports across the frame and out of the frame.

19. The station as recited in claim 18 wherein the grate further comprises a plurality of members that each extend substantially across the entire top of the frame and each member is angled upwardly with respect to the plane of the frame top to vibrate a vehicle traversing the station.

20. The station as recited in claim 19 further comprising a collection pit adjacent the entry port for receiving debris flushed from the frame by water.
